(19) United States
(12) Patent Application Publication
(10) Pub. No.: US 2016/0337364 A1
(43) Pub. Date: Nov. 17, 2016

(54) SYSTEM AND METHOD FOR AUTOMATICALLY MODERATING COMMUNICATIONS USING HIERARCHICAL AND NESTED WHITELISTS

(71) Applicant: YANDEX EUROPE AG, Luzern (CH)

(72) Inventors: Volodymyr GRANKOVSKYI, Donetsk Region, Donetsk (UA); Mikhail Aleksandrovich KHOKHLOV, Moscow Region, Dolgoprudniy (RU)

(21) Appl. No.: 15/110,125

(22) PCT Filed: Dec. 15, 2014
(86) PCT No.: PCT/IB2014/066927

§ 371 Date: Jul. 7, 2016

(30) Foreign Application Priority Data
Jun. 3, 2014 (RU) 2014122443

(51) Int. Cl. H04L 29/06

(52) U.S. Cl. CPC H04L 63/101; H04L 63/102

(57) ABSTRACT

Disclosed are systems and methods for automatically moderating communications using hierarchical and nested whitelists. An example method comprises receiving a message including one or more words; determining whether the words of the message match any words in a first whitelist; determining whether the words of the message match any words in a second whitelist if it is determined that at least one of the words of the message does not match any of the words in the first whitelist; calculating an unacceptability value if it is determined that all of the words of the message match any of the words in the second whitelist; and publishing the message if the unacceptability value is below a predetermined threshold.

### CROSS-REFERENCE

The present application claims convention priority to Russian Patent Application No. 2014122443, filed Jun. 3, 2014, entitled “SYSTEM AND METHOD FOR AUTOMATICALLY MODERATING COMMUNICATIONS USING HIERARCHICAL AND NESTED WHITELISTS” which is incorporated by reference herein in its entirety.

### TECHNICAL FIELD

The disclosure relates generally to the field of online communication, and more specifically to the systems, methods and computer program products for automatically moderating communications using hierarchical and nested whitelists.

### BACKGROUND

Electronic messages, such as communications in voice-controlled services, messages in forums, messages in comment and feedback sections of websites, messages in social media (e.g., Twitter, Facebook, Google+), communications in online chat rooms, and any other electronic messages and communications have become an indispensable part of modern communication. Many of these communication services, such as online chat (e.g., a type of electronic messaging over the Internet that offers real-time transmission of text messages from sender to receiver), offer a type of communication that may generally consist of short messages in order to enable participants to quickly and easily convey and respond to information.

To promote civility and safety among users of the many communication services, a service provider hosting an online environment may desire to prevent the use of obscene language or other inappropriate communication. Various systems that were designed to address this issue have implemented morphological or black list analysis of various communication contents. For example, a black list analysis of a message may include a process of looking up words of the message in a blacklist that includes prohibited language including profanity, sexually explicit language, etc., and may censor the individual words or the entire message if the process determines that such prohibited words are present in the message. This type of analysis, however, is not effective because prohibited language may be misspelled and avoid detection while maintaining its offensive nature when being published. Therefore, there exists an unmet need in the art to improve methods for moderating communications.

### SUMMARY

Disclosed are systems, methods and computer program products for automatically moderating communications using hierarchical and nested whitelists.

According to an aspect, an example method comprises receiving, by a server, a communication including one or more words; determining whether the one or more words of the communication match any words in a first set of words of a first whitelist; approving the communication for publication if it is determined that all of the one or more words of the communication match any of the words in the first set of words of the first whitelist; determining whether the one or more words of the communication match any words in a second set of words of a second whitelist if it is determined that at least one of the one or more words of the communication does not match any of the words in the first set of words of the first whitelist, wherein the second whitelist includes both the first set of words and the second set of words; calculating an unacceptability value if it is determined that all of the one or more words of the communication match any of the words in first set of words and the second set of words of the second whitelist, wherein the unacceptability value is calculated based on a ratio of a number of words in the communication that match the words in the second set of words to a number of words in the communication that match the words in the first set of words; approving the communication for publication if the unacceptability value is below a predetermined threshold; and rejecting the communication for publication if the unacceptability value is equal to or above the predetermined threshold.

In another example, the first set of words of the first whitelist are associated with a highest level of trust, and wherein the second set of words of the second whitelist are associated with a level of trust that is lower than the highest level of trust.

In another example, the method further assigning a loyalty coefficient to the communication corresponding to a lowest level of trust among the one or more words of the communication.

In another example, the method further comprises analyzing a word of the one or more words of the communication against a blacklist if it is determined that the word does not match any of the words in any of the whitelists.

In another example, the method further comprises transmitting the communication for analysis by a human moderator if it is determined that at least one of the one or more words does not match any of the words in any of the whitelists.

In another example, the communication is one of an online chat message, a text message converted from voice, a short message service (SMS) text message, a message provided in an online forum, a message provided in an online comment section, a message provided in an online feedback system, a message provided via a social media service.

In another example, the method further comprises determining a communications ratio of a first number of communications having an unacceptability value at or above the threshold and a second number of communications having an unacceptability value below the threshold.

In another example aspect, the communications ratio may be used for determining the threshold, which is used for determining the unacceptability of the communication.

In another example, a relationship between the communications ratio and the unacceptability value may be substantially monotonic.

According to yet another aspect, an example system for automatically moderating communications, comprises a database comprising a first whitelist including a first set of words and a second whitelist including the first set of words and a second set of words; a service module configured to receive a communication including one or more words; and a moderation module configured to determine whether the one or more words of the communication match any words in the first set of words of the first whitelist; approve the communication for publication if it is determined that all of the one or more words of the communication match any of the words in the first set of words of the first whitelist; determine whether the one or more words of the communication match any words in the second set of words of the second whitelist if it is determined that at least one of the one or more words of the communication does not match any of the words in the first set of words of the first whitelist; calculate an unacceptability value if it is determined that all of the one or more words of the communication match any of the words in first set of words and the second set of words of the second whitelist, wherein the unacceptability value is calculated based on a ratio of a number of words in the communication that match the words in the second set of words to a number of words in the communication that match the words in the first set of words; approve the communication for publication if the unacceptability value is below a predetermined threshold; and reject the communication for publication if the unacceptability value is equal to or above the predetermined threshold.

According to an aspect, an example method comprises receiving, by a server, a communication including one or more words; determining whether the one or more words of the communication match any words in a first set of words of a first whitelist; performing an action approving the communication if it is determined that all of the one or more words of the communication match any of the words in the first set of words of the first whitelist; determining whether the one or more words of the communication match any words in a second set of words of a second whitelist if it is determined that at least one of the one or more words of the communication does not match any of the words in the first set of words of the first whitelist, wherein the second whitelist includes both the first set of words and the second set of words; calculating an unacceptability value if it is determined that all of the one or more words of the communication match any of the words in first set of words and the second set of words of the second whitelist, wherein the unacceptability value is calculated based on a ratio of a number of words in the communication that match the words in the second set of words to a number of words in the communication that match the words in the first set of words; performing an action approving the communication if the unacceptability value is below a predetermined threshold; and performing an action rejecting the communication if the unacceptability value is equal to or above the predetermined threshold.

In another example, the method further comprises publishing the communication.

In another example, the method further comprises transmitting a communication to a service indicating that the communication is approved for publishing.

The above simplified summary of example aspects serves to provide a basic understanding of the invention. This summary is not an extensive overview of all contemplated aspects, and is intended to neither identify key or critical elements of all aspects nor delineate the scope of any or all aspects of the invention. Its sole purpose is to present one or more aspects in a simplified form as a prelude to the more detailed description of the invention that follows. To the accomplishment of the foregoing, the one or more aspects of the invention include the features described and particularly pointed out in the claims.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations.

FIG. 1 is a diagram illustrating an example aspect of a system for automatically moderating communications using hierarchical and nested whitelists according to one aspect of the invention.

FIG. 2 is a diagram illustrating an example aspect of a web browser displaying a map request entry webpage of a system for automatically moderating communications using hierarchical nested whitelists according to one aspect of the invention.

FIGS. 3A-3C are diagrams illustrating an example aspect of a map webpage of a system for automatically moderating communications using hierarchical and nested whitelists according to one aspect of the invention.

FIGS. 4A-C are graphs illustrating plots of algorithms that determine an unacceptability of communications when moderating communications using hierarchical and nested whitelists according to one aspect of the invention.

FIG. 5 is a flow diagram illustrating an example method for automatically moderating communications using hierarchical and nested whitelists according to one aspect of the invention.

FIG. 6 is a diagram illustrating an example aspect of a general-purpose computer system on which are implemented the systems and methods for automatically moderating communications using hierarchical and nested whitelists in accordance with aspects of the invention.

### DETAILED DESCRIPTION

Example aspects of the present invention are described herein in the context of systems, methods and computer program products for automatically moderating communications using hierarchical and nested whitelists. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same items.

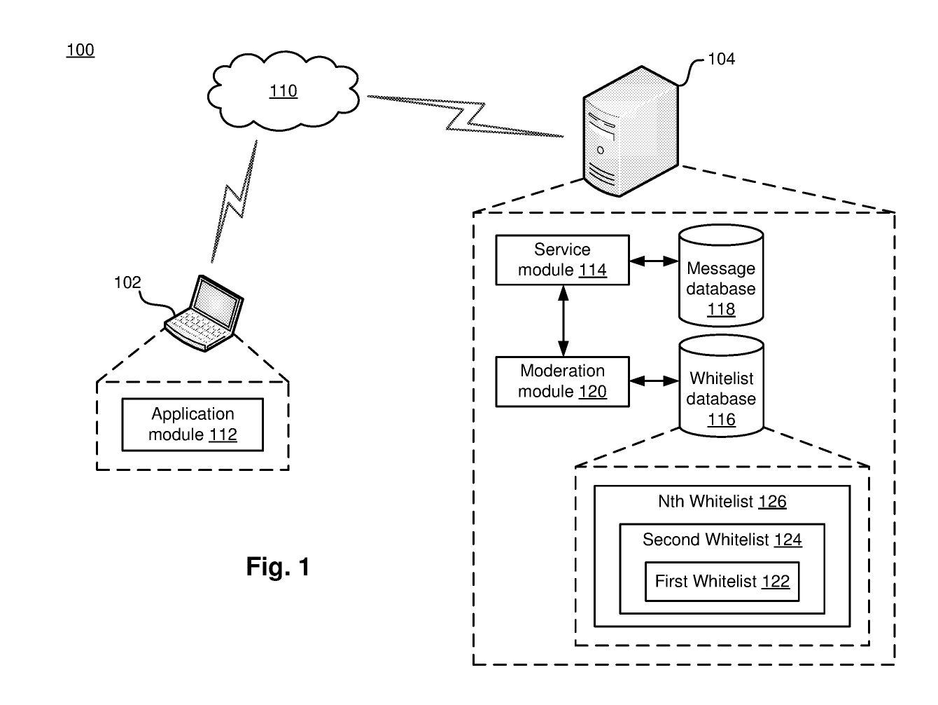

FIG. 1 depicts an example system 100 for automatically moderating communications using hierarchical and nested whitelists according to one aspect of the invention. The system 100 may include various electronic user devices 102, such as a mobile device, a desktop computer, a laptop, etc. In one aspect, a device 102 may include an application module 112. The device 102 may be connected to a network 110, such as the Internet, via a wired or wireless connection. Also connected to the network 110 may be a server 104. In one aspect, the server 104 may host one or more services, such as a map service that provides geographic map data to various user devices, such as device 102. In one aspect, the server 104 may include a service module 114, a whitelist database 116, a message database 118, and a moderation module 120. The functionality of each of the modules of the device 102 and the server 104 will be described in greater detail below.

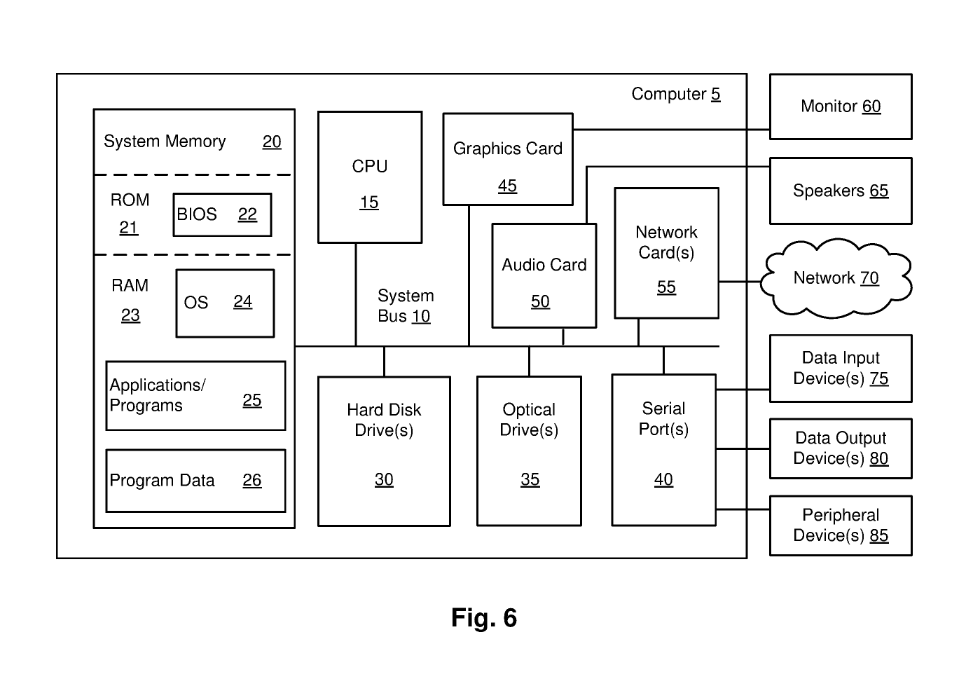

The term “module” as used herein means a real-world device, apparatus, or arrangement of modules implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 6 below). Accordingly, each module can be realized in a variety of suitable configurations, and should not be limited to any particular implementation exemplified herein.

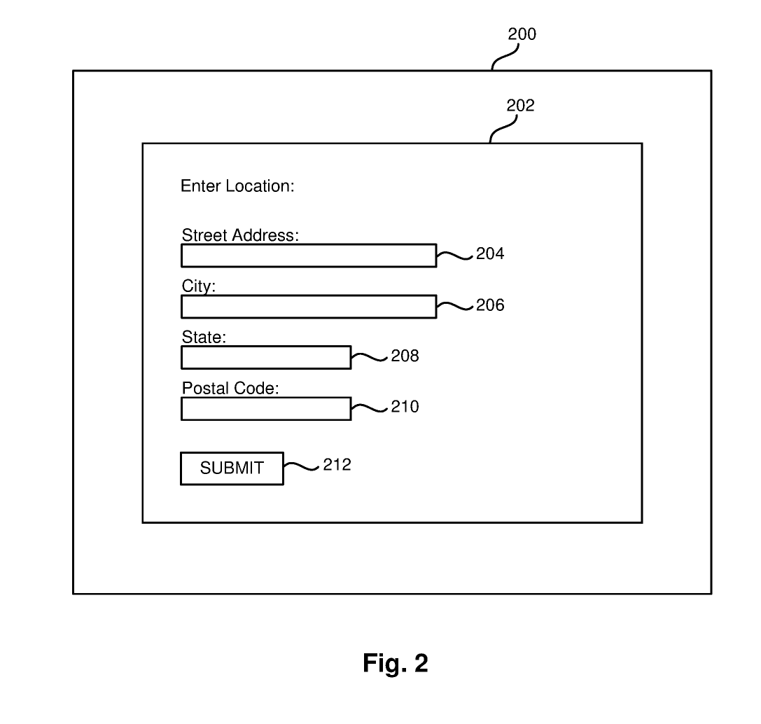

The application module 112 of the device 102 shown in FIG. 1 may be a web browser or any application that allows a user to access a communication service, such as an online service, or as shown by example here, a map service provided by the server 104, via the network 110. It should be noted that the communication service may be any type of service that provides an ability for users to convey messages comprising text, such as voice-controlled services that allow conversion of voice to text (e.g., for banking, insurance, phone surveys, taxi dispatch systems), short message service (SMS) texts, messages in forums, messages in comment and feedback sections of websites, messages in social media (e.g., Twitter, Facebook, Google+), communications in online chat rooms, and any other electronic messages and communications. For example, the communication service may support text- and voice-based communications in different languages. In various aspects, the communication service may be provided via an application server, such as a PC application, a mobile app, a website, or a script embedded in a third-party website. For example, FIG. 2 illustrates an example aspect of a web browser with a user interface 200 displaying a map request entry webpage 202 of a system for automatically moderating communications using hierarchical ad nested whitelists according to one aspect of the invention. The map request entry webpage 202 may be hosted and provided by the service module 114. As shown in FIG. 2, the map request entry webpage 202 may include a number of text fields for entering specific location information, such as street address 204, city 206, state 208, and postal code (e.g., zip code) 210. After entering the desired location to be mapped, the user may then request a map from the server 104 by selecting a “submit” button 212. A map image may then be generated at the server 104, transmitted to the user's device 102, and eventually displayed on the web browser user interface 200 in a map webpage.

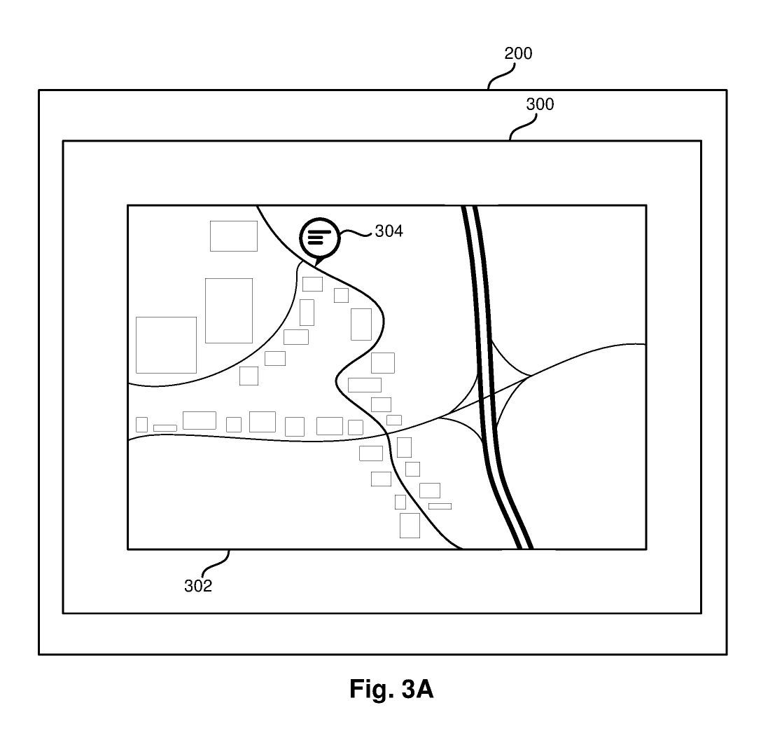

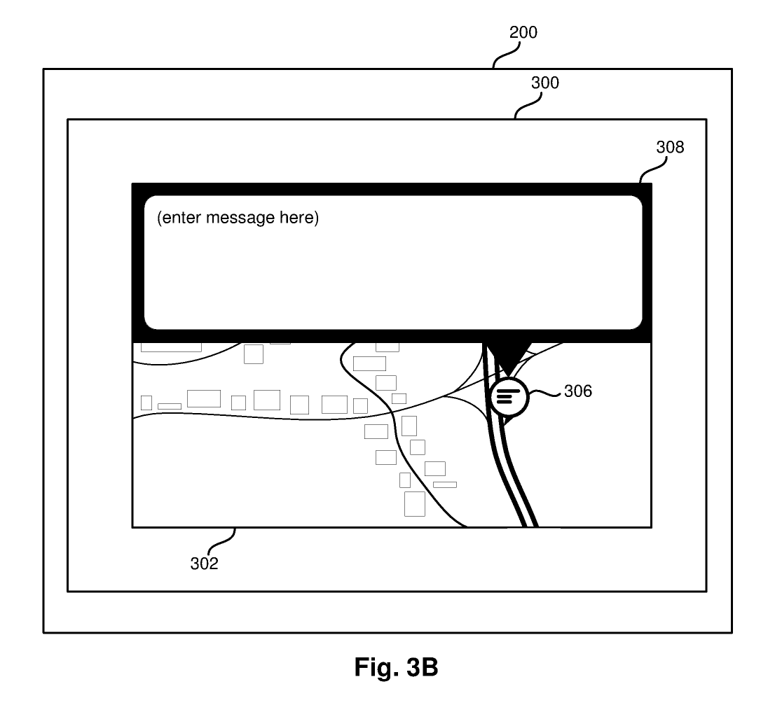

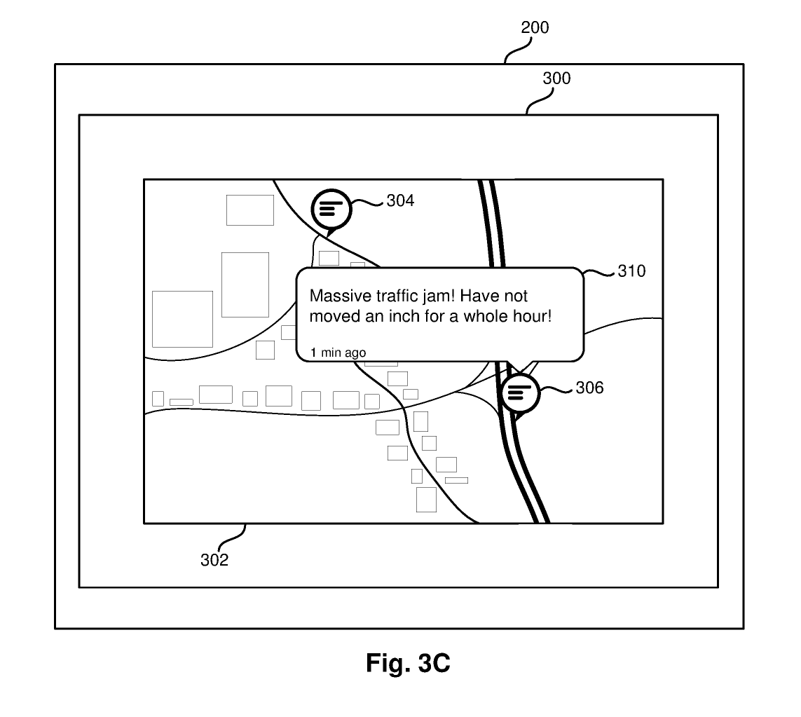

FIG. 3A illustrates an exemplary map webpage 300 on the web browser user interface 200. As shown in FIG. 3A, the map webpage 300 may display the results of the map request from FIG. 2. The displayed information may consist of a map image 302, which depicts the requested location and surrounding area. The map webpage may also implement a chat system that allows users to publish chat messages associated with specific geographic (e.g., street) locations. For example, the map image 302 may include a chat icon 304 indicating that a user has published a chat message concerning a specific point on a road that is designated by the chat icon 304. The chat message may be viewed by selecting the chat icon 304. The chat icons 304 may be placed by any user of the map service and may be visible to and viewed by all or a specified one or a group of users accessing the map service. For example, as shown in FIG. 3B, a user may place a chat icon 306 on a specific location on the map image 302. Alternatively, the map server may automatically determine the geographical location of the user (e.g., via triangulation, GPS, etc.) and at the user's request place a chat icon on the user's current location. Once the chat icon 306 is placed, the map webpage 300 may display a chat window 308 to allow the user to enter a text message. The user may then input a text message in the chat window 308 and submit the text message.

When the user submits the text message, the device 102 may transmit a signal including the text message and the designated map location to the service module 114 of the server 104. The service module 114 may receive the signal and forward the text message portion of the signal to the moderation module 120 for analysis. The moderation module 120 may perform a moderation process on the text message to ensure that the text message is not offensive, does not contain any obscene language, or other inappropriate communication. The moderation module 120 may receive the text message and convert the text message into a machine-readable message by, for example, deleting punctuation, deleting numbers, dividing the message word by word, changing all letters to lower case, deleting repeated spaces, organizing letters into registers, etc. The moderation module 120 may then access the whitelist database 116 and check each of the words of the machine-readable message against a set of words of a whitelist that is stored in the whitelist database 116.

The whitelist database 116 may include a number of nested whitelists organized in a hierarchical manner based on a level of trust. Each whitelist may include a set of words associated with a specific level of trust. The set of words for each whitelist may be created based on previously human-moderated messages. For example, the whitelist database 116 may include a first whitelist 122 that includes a first set of words that are associated with a first level of trust. The first level of trust may be a “highest level of trust” indicating that the first set of words includes words that are suitable for all ages (e.g., words that do not include inappropriate language, such as profanity, or other suggestive and age-inappropriate words). The whitelist database 116 may also include a second whitelist 124 that includes a second set of words that are associated with a second level of trust. The second level of trust may be a “medium level of trust” indicating that the second set of words includes words that are not suitable for a specific age group (e.g., words of a mature nature). It should be noted that the second whitelist 124 also includes the first set of words of the first whitelist 122 such that some words in the second whitelist 124 may be from the first set of words and other words may be from the second set of words. The whitelist database 116 may include any number of whitelists, where each subsequent whitelist includes a set of words that are associated with a lower level of trust. For example, the whiteliset database 116 may include up to an nth whitelist 126 that includes an nth set of words that are associated with an nth level of trust (e.g, lowest level of trust). The nth whitelist 126 may also include the sets of words of all preceding whitelist, such as the first set of words of the first whitelist 122 and the second set of words of the second whitelist 124.

In accordance with an alternative aspect, the whitelists may be organized in a hierarchical manner, but may not be nested, and instead may each include a particular set of words associated with a particular level of trust where each set of words is exclusive of the words of all other sets of words.

In accordance with an aspect, when the moderation module 120 initially access the whitelist database 116, it would access the first whitelist 122 to check each of the words of the machine-readable message against the first set of words of the first whitelist 122.

If the moderation module 120 determines that a word in the message matches a word in the first set of words of the first whitelist 122, then the moderation module 120 may designate the matching word with a loyalty coefficient. The loyalty coefficient indicates a level of trustworthiness of the words and is based on the level of trust of the whitelist where the matching word was found. For example, a word in the message matches a word in the first set of words of the first whitelist 122, then the matching word is designated with a loyalty coefficient X, indicating the highest level of trust. If the word in the message does not match any of the words in the first set of words of the first whitelist 122, but matches a word in the second set of words of the second whitelist 124, then the matching word is designated with a loyalty coefficient Y, indicating a level of trust that is lower than that of loyalty coefficient X, and so on. If the word in the message does not match any words in any set of words of any of the whitelists, then the moderation module 120 may mark the whole message that includes this word as “undefined” and may proceed to transmit the message to a human moderator or another additional system for additional analysis (e.g., a system that analyzes the non-matching word with words in a blacklist). The additional analysis may result in determining that the word is associated with a particular level of trust, and the human moderator or the other system may add the word to a set of words of a particular whitelist based on the word's determined level of trust.

Once all of the words of the message have been matched and designated with an appropriate loyalty coefficient, the moderation module 120 may mark the message with its own loyalty coefficient that corresponds to the lowest loyalty coefficient of the words in the message. For example, if the message includes six words, where five of the words are designated with a loyalty coefficient X and where one of the words is designated with a loyalty coefficient Y, the moderation module 120 would mark the message with a loyalty coefficient Y because the word with the loyalty coefficient Y (having a lower level of trust than the other words with the loyalty coefficient X) would govern the loyalty coefficient of the whole message.

If the moderation module 120 determines that all of the words in the message are designated with a loyalty coefficient X (i.e., all the words in the message match words in the first set of words of the first whitelist 122), then the moderation module 120 marks the message with a loyalty coefficient X and may instruct the service module 114 to publish the text message in the online chat. For example, the user may have entered the text “Massive traffic jam! Have not moved an inch for a whole hour!” All of the words of this text message may be located in the first set of words of the first whitelist having the first (e.g., highest) level of trust, and upon determining as much, the moderation module 120 may designate all of the words with a loyalty coefficient X, mark the message with a loyalty coefficient X, and allow publication of the text message. The service module 114 may then store the text message in the message database 118 and publish the text message along with its designated map location to the chat system.

Once the text message is published, the chat icon 306 may be visible to other map users, and may display the published text message once the chat icon 306 is selected. For example, as shown in FIG. 3C, once a user selects the chat icon 306, the chat system may display a chat box showing the text “Massive traffic jam! Have not moved an inch for a whole hour!” The chat box may also show the age of the text message (e.g., text message was published “1 min ago”).

If the moderation module 120 determines that at least one of the words of the machine-readable message does not match any of the words in the first set of words of the first whitelist 122, then the moderation module 120 may access the whitelist database 116 and check the non-matching words(s) against the second set of words of the second whitelist 124.

If the moderation module 120 determines that all of the remaining words of the machine-readable message match words in the second set of words of the second whitelist 124, then the moderation module 120 may designate the remaining words with a loyalty coefficient Y, e.g., mark the message with the loyalty coefficient Y. The moderation module 120 may then calculate an unacceptability value of the message, which may include calculating a ratio of a number of words in the message having a loyalty coefficient Y to the number of words in the message having a loyalty coefficient X. For example, if the machine-readable message contains two words with loyalty coefficient X and one word with loyalty coefficient Y, the moderation module 120 may then calculate the threshold and determine that the message in general refers to the X loyalty coefficient. In that case, the moderation module 120 determines the number of words with each loyalty coefficient and mathematically compares the number of the respective loyalty coefficients. However, if at least one word matches the “least loyal” set of the words (say, foul language), the moderation module 120 may associate the whole message with the least loyal loyalty coefficient. Furthermore, in another example, if the moderation module 120 calculates that there are two words with loyalty coefficient Y and two words with the loyalty coefficient X, the moderation module 120 may take in consideration the least loyal coefficient. The moderation module 120 may then compare the calculated ratio with a predetermined threshold. If the ratio (i.e., the unacceptability value) is less than the threshold, the moderation module 120 may designate the message as “acceptable” and instruct the service module 114 to publish the text message. On the other hand, if the ratio is greater than the threshold, the moderation module 120 may designate the message as “unacceptable” and instruct the service module 114 to not publish the text message (e.g., reject the message) and, for example, notify the user who submitted the text message that the text message is unacceptable.

If the moderation module 120 determines that at least one of the words of the machine-readable message does not match any of the words in the second set of words of the second whitelist 124, then the moderation module 120 may access the whitelist database 116 and check the non-matching words(s) against the set of words of a subsequent whitelist. The moderation module 120 may repeat the procedure described above until it determines that at least one of the words of the machine-readable message does not match any of the words in any of the whitelists (e.g., at least one word does not match any of the words in the nth whitelist 126). As explained above, if at least one word in the message does not match any words in any set of words of any of the whitelists (e.g., the nth whitelist 126), then the moderation module 120 may mark the whole message that includes this word as “undefined” and may proceed to transmit the message to a human moderator or a system that analyzes the non-matching word with words in a blacklist. The additional analysis may result in determining that the word is associated with a particular level of trust, and the human moderator or the other system may add the word to a set of words of a particular whitelist based on the word's determined level of trust. Then, based on the word's association with a particular whitelist, the moderation module 120 may proceed with the acceptability analysis of the message described above.

For example, in accordance with one aspect, the additional analysis may include a calculation of a new unacceptability value of the message based on the following formula: bnew=b(1+maxi unacceptability(wordi))rate. Here, “bnew” is the new unacceptability value of the message, and “wordi” corresponds to all the words in the message. The term “unacceptability(wordi)” corresponds to the combination of unacceptability values “unacceptability(word)” of all the words in the message. An unacceptability value for an unacceptability value “unacceptability(word)” may be taken from the blacklist or be equal to 0 if there is no such word in a blacklist. The term “rate” may be chosen experimentally or may be arbitrarily assigned a value of 0.6 or 0.7 for example. If the unacceptability “bnew” of the message is less than the threshold, then the message is marked as acceptable and may be allowed for publication. If, however, the unacceptability “bnew” of the message is equal to or greater than the threshold, then the message is marked as unacceptable and may be rejected.

Accordingly, in this manner, the chat/text messages of the user of the device 102 are moderated using hierarchical and nested whitelists.

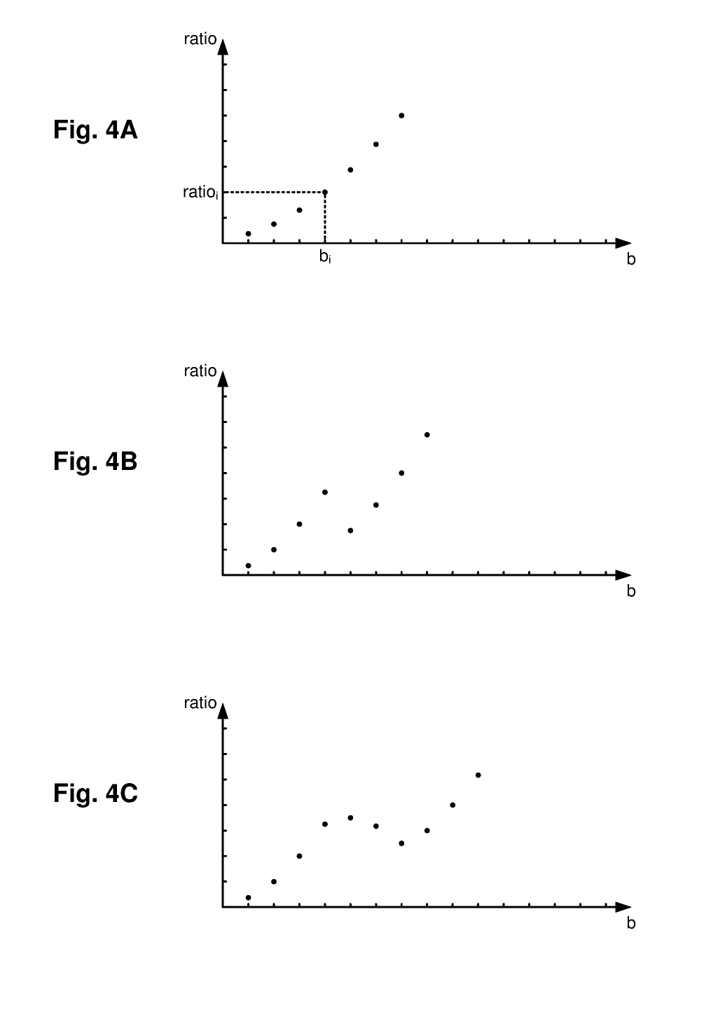

FIG. 4A is a graph illustrating a plot of an algorithm that determines an unacceptability of messages implemented by example system 100 for automatically moderating communications using hierarchical and nested whitelists according to one example aspect. The graph includes a vertical axis representing a “ratio” of “good” messages to “bad” messages, which will be described in the following paragraphs, and a horizontal axis representing an unacceptability “b” of the messages. The ratio of good message to band message will be interchangeably referred to herein below as a message ratio or a communications ratio.

The moderation module 120 may calculate a constant value “H”, which represents a value of the “unacceptability” of a message that includes words not found in any of the whitelists. In one example aspect, the moderation module 120 may calculate “H” using an iterating algorithm that minimizes the limitations of a histogram that is a result of the moderation process with the current value of “H”.

Using the moderation process described above that is able to calculate the loyalty coefficient of the communication or message (e.g., an unacceptability value of the message), moderation module 120 may determine the value “H” that will provide the following: in the moderation process of a large amount of messages from the individual training set of messages with the current value of “H”, the ratio between the number of truly bad (e.g., truly unacceptable) messages and truly good (e.g., truly acceptable) messages should change as monotonically as possible upon the increase of the unacceptability value “b” calculated at the moderation process.

It may be assumed, that the unacceptability of the multiple messages from the individual training set was calculated for some specific value “Hj”. Then the moderation module 120 may divide the scale of the calculated unacceptability into equal segments having centers in the values “bi(i=1 . . . N)”. This means that all the messages having a calculated unacceptability of “ε(bi−Δ;bi+Δ]” will fall into each segment, where “2Δ” is the width of the segment. All the messages can be either truly unacceptable or truly acceptable. It may also be assumed that each segment “i” (having the center in “bi”, as shown in FIG. 4A) may have a “goodi” of truly good messages and “badi” of truly bad messages. As such, the moderation module 120 may determine a message ratio of “badi” messages to “goodi” messages (i.e., “ratioi=badi/goodi”).

As shown in FIG. 4A, the message ratio may increase with the increase of “b”, which is an acceptable scenario. The worse the calculated unacceptability (i.e., the greater the value of “b”) the greater is the likelihood that the message is truly bad. Because the function is substantially monotonic (i.e., having no decreasing ratio values for sequential values of unacceptability “b”), the moderation process is behaving properly. In some cases, however, for certain parameters “H” and message ratio values, the function may become non-monotonic.

FIG. 4B and FIG. 4C show such a plot of an algorithm that determines an unacceptability of messages implemented by example system 100 for automatically moderating communications using hierarchical and nested whitelists according to one aspect of the invention. As shown in FIGS. 4B and 4C, the function may be non-monotonic (i.e., having both increasing and decreasing ratio values for sequential values of unacceptability b), and so the parameters may need to be changed. The function may also not be ideally or substantially monotonic for any parameters “H” or ratio values. The value ratei may also exhibit a different degree of accuracy. For example, the accuracy of ratei may decrease when the value of “badi+goodi” decreases. The value of “ratei” with the lower degree of accuracy may have less influence on the function and thus the quality of monotony. The accuracy of “ratei” may be especially low for a large “I” because of the large amount of messages that “ratei” encompasses.

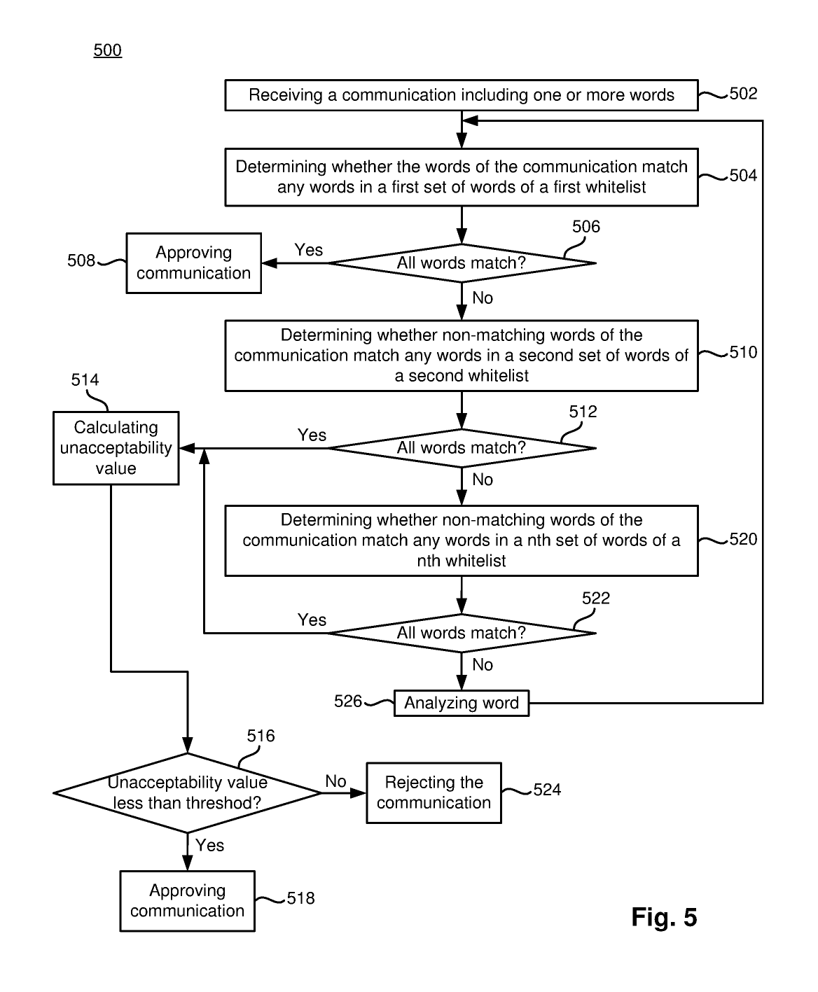

FIG. 5 is a flow diagram illustrating an example method 500 for automatically moderating communications using hierarchical and nested whitelists according to one aspect of the invention. The process described in this flow diagram may be implemented in a server providing an online service, such as the server 104. As shown in FIG. 4, the process may begin in block 502, where a server may receive a communication including one or more words. For example, the service module 114 of the server 104 may receive the communication and forward the communication to the moderation module 120. In block 504, the moderation module 120 may determine whether the one or more words of the communication match any words in a first set of words of a first whitelist 122. In block 506, if the moderation module 120 determines that all of the one or more words of the communication match any of the words in the first set of words of the first whitelist, then the process proceeds to block 508, where the service module 114 publishes the communication. If, on the other hand, the moderation module 120 determines that at least one of the one or more words of the communication does not match any of the words in the first set of words of the first whitelist, then the process proceeds to block 510.

In block 510, the moderation module 120 determines whether the one or more words of the communication match any words in a second set of words of a second whitelist. It should be noted that the second whitelist includes both the first set of words and the second set of words. In block 512, if the moderation module 120 determines that all of the one or more words of the communication match any of the words in first set of words and the second set of words of the second whitelist, then the process proceeds to block 514, otherwise, the process proceeds to block 520.

In block 520, the moderation module 120 determines whether the one or more words of the communication match any words in a set of words of a subsequent whitelist, such as a nth set of words of a nth whitelist. It should be noted that the nth whitelist also includes all of the sets of words of the preceding whitelists. In block 522, if the moderation module 120 determines that all of the one or more words of the communication match any of the words in all the sets of words of the nth whitelist, then the process proceeds to block 514, otherwise, the process proceeds to block 524. In block 524, after it is determined that the one or more words does not match any words in the nth whitelist, then the moderation module 120 may mark the whole communication that includes this word as “undefined” and may proceed to transmit the communication to a human moderator or a system that analyzes the non-matching word with words in a blacklist, for example. The additional analysis may result in determining that the word is associated with a particular level of trust, and the human moderator or the other system may add the word to a set of words of a particular whitelist based on the word's determined level of trust. Then, the process may proceed back to block 504.

In block 514, the moderation module 120 may calculate an unacceptability value based on a ratio of a number of words in the communication that match the words in the second set of words to a number of words in the communication that match the words in the set of words of each subsequent whitelist.

In block 516, the moderation module 120 determines whether the unacceptability value is below a predetermined threshold. If so, in block 518, the service module 114 publishes the communication. If not, then in block 524 the service module rejects the communication.

FIG. 6 depicts one example aspect of a computer system 5 that may be used to implement the disclosed systems and methods for automatically moderating communications using hierarchical and nested whitelists according to one aspect of the invention. The computer system 5 may include, but not limited to, a personal computer, a notebook, tablet computer, a smart phone, a mobile device, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the invention, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for automatically moderating communications, the method comprising:
receiving, by a server, a communication including one or more words;
determining whether the one or more words of the communication match any words in a first set of words of a first whitelist;
approving the communication for publication if it is determined that all of the one or more words of the communication match any of the words in the first set of words of the first whitelist;
determining whether the one or more words of the communication match any words in a second set of words of a second whitelist if it is determined that at least one of the one or more words of the communication does not match any of the words in the first set of words of the first whitelist, wherein the second whitelist includes both the first set of words and the second set of words;
calculating an unacceptability value if it is determined that all of the one or more words of the communication match any of the words in first set of words and the second set of words of the second whitelist, wherein the unacceptability value is calculated based on a ratio of a number of words in the communication that match the words in the second set of words to a number of words in the communication that match the words in the first set of words;
approving the communication for publication if the unacceptability value is below a predetermined threshold; and
rejecting the communication for publication if the unacceptability value is equal to or above the predetermined threshold.

2. The method of claim 1, wherein the first set of words of the first whitelist are associated with a highest level of trust, and wherein the second set of words of the second whitelist are associated with a level of trust that is lower than the highest level of trust.

3. The method of claim 2, further comprising assigning a loyalty coefficient to the communication corresponding to a lowest level of trust among the one or more words of the communication.

4. The method of claim 1, further comprising analyzing a word of the one or more words of the communication against a blacklist if it is determined that the word does not match any of the words in any of the whitelists.

5. The method of claim 1, further comprising transmitting the communication for analysis by a human moderator if it is determined that at least one of the one or more words does not match any of the words in any of the whitelists.

6. The method of claim 1, wherein the communication is one of an online chat message, a text message converted from voice, a short message service (SMS) text message, a message provided in an online forum, a message provided in an online comment section, a message provided in an online feedback system, a message provided via a social media service.

7. The method of claim 1, further comprising determining a communications ratio of a first number of communications having an unacceptability value at or above the threshold and a second number of communications having an unacceptability value below the threshold.

8. The method of claim 7, wherein the communications ratio is used for determining the threshold used for determining the unacceptability of the received communication.

9. The method of claim 7, wherein a relationship between the communications ratio and the unacceptability value is substantially monotonic.

10. A system for automatically moderating communications, the system comprising:
a database comprising a first whitelist including a first set of words and a second whitelist including the first set of words and a second set of words;
a service module configured to receive a communication including one or more words; and
a moderation module configured to:
determine whether the one or more words of the communication match any words in the first set of words of the first whitelist;
approve the communication for publication if it is determined that all of the one or more words of the communication match any of the words in the first set of words of the first whitelist;
determine whether the one or more words of the communication match any words in the second set of words of the second whitelist if it is determined that at least one of the one or more words of the communication does not match any of the words in the first set of words of the first whitelist;
calculate an unacceptability value if it is determined that all of the one or more words of the communication match any of the words in first set of words and the second set of words of the second whitelist, wherein the unacceptability value is calculated based on a ratio of a number of words in the communication that match the words in the second set of words to a number of words in the communication that match the words in the first set of words;
approve the communication for publication if the unacceptability value is below a predetermined threshold; and
reject the communication for publication if the unacceptability value is equal to or above the predetermined threshold.

11. The system of claim 10, wherein the first set of words of the first whitelist are associated with a highest level of trust, and wherein the second set of words of the second whitelist are associated with a level of trust that is lower than the highest level of trust.

12. The system of claim 11, wherein the moderation module is further configured to assign a loyalty coefficient to the communication corresponding to a lowest level of trust among the one or more words of the communication.

13. The system of claim 10, wherein the moderation module is further configured to analyze a word of the one or more words of the communication against a blacklist if it is determined that the word does not match any of the words in any of the whitelists.

14. The system of claim 10, wherein the moderation module is further configured to transmit the communication for analysis by a human moderator if it is determined that at least one of the one or more words does not match any of the words in any of the whitelists.

15. The system of claim 10, wherein the communication is one of an online chat message, a text message converted from voice, a short message service (SMS) text message, a message provided in an online forum, a message provided in an online comment section, a message provided in an online feedback system, a message provided via a social media service.

16. The system of claim 10, wherein the moderation module is further configured to determine a communications ratio of a first number of communications having an unacceptability value at or above the threshold and a second number of communications having an unacceptability value below the threshold.

17. The system of claim 16, wherein the communications ratio is used for determining the threshold used for determining the unacceptability of the received communication.

18. The system of claim 16, wherein a relationship between the communications ratio and the unacceptability value is substantially monotonic.

19. A method for automatically moderating communications, the method comprising:
receiving, by a server, a communication including one or more words;
determining whether the one or more words of the communication match any words in a first set of words of a first whitelist;
performing an action approving the communication if it is determined that all of the one or more words of the communication match any of the words in the first set of words of the first whitelist;
determining whether the one or more words of the communication match any words in a second set of words of a second whitelist if it is determined that at least one of the one or more words of the communication does not match any of the words in the first set of words of the first whitelist, wherein the second whitelist includes both the first set of words and the second set of words;
calculating an unacceptability value if it is determined that all of the one or more words of the communication match any of the words in first set of words and the second set of words of the second whitelist, wherein the unacceptability value is calculated based on a ratio of a number of words in the communication that match the words in the second set of words to a number of words in the communication that match the words in the first set of words;
performing an action approving the communication if the unacceptability value is below a predetermined threshold; and
performing an action rejecting the communication if the unacceptability value is equal to or above the predetermined threshold.

20. The method of claim 19, wherein the first set of words of the first whitelist are associated with a highest level of trust, and wherein the second set of words of the second whitelist are associated with a level of trust that is lower than the highest level of trust.

21. The method of claim 20, further comprising assigning a loyalty coefficient to the communication corresponding to a lowest level of trust among the one or more words of the communication.

22. The method of claim 19, further comprising analyzing a word of the one or more words of the communication against a blacklist if it is determined that the word does not match any of the words in any of the whitelists.

23. The method of claim 19, further comprising transmitting the communication for analysis by a human moderator if it is determined that at least one of the one or more words does not match any of the words in any of the whitelists.

24. The method of claim 19, wherein the communication is one of an online chat message, a text message converted from voice, a short message service (SMS) text message, a message provided in an online forum, a message provided in an online comment section, a message provided in an online feedback system, a message provided via a social media service.

25. The method of claim 19, wherein performing the action approving the communication comprises publishing the communication.

26. The method of claim 19, wherein performing the action approving the communication comprises transmitting a communication to a service indicating that the communication is approved for publishing.

27. The method of claim 19, further comprising determining a communications ratio of a first number of communications having an unacceptability value at or above the threshold and a second number of communications having an unacceptability value below the threshold.

28. The method of claim 27, wherein the communications ratio is used for determining the threshold used for determining the unacceptability of the received communication.

29. The method of claim 27, wherein a relationship between the communications ratio and the unacceptability value is substantially monotonic.
